(19) United States
(12) Patent Application Publication
(10) Pub. No.: US 2006/0220557 A1
(43) Pub. Date: Oct. 5, 2006

(54) Plasma display panel

(75) Inventors: Koji Sugawa, Kawasaki (JP); Nobuhiro Iwase, Kawasaki (JP); Tetsurou Kawakita, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Hitachi Plasma Display Limited, Kawasaki (JP)

(21) Appl. No.: 11/389,015

(22) Filed: Mar. 27, 2006

(30) Foreign Application Priority Data
Mar. 31, 2005 (JP) 2005-102921

(51) Int. Cl. H01J 17/49

(52) U.S. Cl. 313/586; 313/587

(57) ABSTRACT

A plasma display panel includes a pair of substrates, a dielectric layer, a protective film, and a discharge gas. The pair of substrates are disposed in an opposite relation with a discharge space defined therebetween. The dielectric layer is formed on at least one of the substrates so that the dielectric layer covers a plurality of electrodes formed on said at least one of the substrates. The protective film is formed on the dielectric layer so that the protective film covers the dielectric layer. The discharge gas is filled in the discharge space and contains xenon. The dielectric layer is formed of a material containing silicon oxide. The protective film is formed of a material that has little aptitude to pass ultraviolet light generated by an electric discharge between the electrodes.

### CROSS-REFERENCE TO RELATED APPLICATION

This application is related to Japanese application No. 2005-102921 filed on Mar. 31, 2005, whose priority is claimed and the disclosure of which is incorporated by reference in its entirety.

### BACKGROUND OF THE INVENTION

1. Field of the Invention

The present invention relates to a plasma display panel (hereafter referred to as “PDP”) and, more particularly, to a PDP in which contamination of a discharge gas filled in the inside of the PDP is prevented.

2. Description of Related Art

Among conventional PDPs, there are known AC-driven three-electrode surface-discharge PDPs. In a PDP of this type, a front substrate (display-side substrate) has on an inner surface thereof a plurality of display electrodes arranged horizontally for generation of a surface discharge, and a rear substrate has on an inner surface thereof a plurality of address electrodes arranged in a direction crossing the display electrodes for selection of a cell to be lit. An intersection of two display electrodes, with one address electrode is one cell.

The display electrodes on the front substrate are covered with a dielectric layer on which a protective film is formed. The address electrodes on the rear substrate are also covered with a dielectric layer on which barrier ribs in stripes or in a mesh are formed with phosphor layers provided between the barrier ribs.

The front substrate and rear substrate with the above constitutions are disposed in an opposite relation and sealed together at the periphery and then a discharge gas is fed into the inside of the PDP to produce the PDP, as disclosed in Japanese Unexamined Patent Publication No. 2000-21304.

Display is performed as follows. A surface discharge is generated between the display electrodes, and phosphor contained in the phosphor layers is excited with ultraviolet light emitted during the surface discharge, so that the phosphor emits visible light.

In the above PDP, when attention is given to the front substrate, the dielectric layer is obtained by forming a SiO₂ film through CVD, vapor deposition or the like. Or, the dielectric layer is obtained by applying a low-melting glass paste and firing the resulting low-melting glass paste layer. The protective film is formed of a MgO film.

The MgO film, however, has an aptitude to pass VUV (vacuum ultraviolet light). The SiO₂ film also has an aptitude to pass the VUV. When the protective film is formed of the MgO film and the dielectric layer is formed of the SiO₂ film, therefore, VUV generated by a surface discharge enters the SiO₂ film beneath the MgO film. Due to the energy of the VUV, the SiO₂ film releases an impurity gas containing, as a main component, hydrogen, ammonia or the like, which is an undecomposed substance. As the impurity gas gradually accumulates due to repeated electric discharges, its concentration in the discharge gas filled in the PDP increases, which could adversely affect the discharge characteristics and the life of the PDP.

### SUMMARY OF THE INVENTION

The present invention has been made in view of these circumstances. The main purpose thereof is to provide a PDP in which a protective film is formed of a material which has little aptitude to pass VUV such as an alkaline earth metal oxide so that VUV generated during an electric discharge is blocked from entering a dielectric layer and thus generation of an impurity gas from the dielectric layer is prevented, whereby contamination of a discharge gas filled in the PDP is prevented to ensure stabilized discharge characteristics and a long life of the PDP.

The present invention provides a plasma display panel comprising: a pair of substrates disposed in an opposite relation with a discharge space defined therebetween; a dielectric layer formed on at least one of the substrates so that the dielectric layer covers a plurality of electrodes formed on said at least one of the substrates; a protective film formed on the dielectric layer so that the protective film covers the dielectric layer; and a discharge gas filled in the discharge space, the discharge gas containing xenon, wherein the dielectric layer is formed of a material containing silicon oxide, and the protective film is formed of a material that has little aptitude to pass ultraviolet light generated by an electric discharge between the electrodes.

### BRIEF DESCRIPTION OF THE DRAWINGS

FIGS. 1 (a) and 1(b) are explanatory views showing the construction of the PDP according to the present invention;

FIG. 2 is an enlarged view of one cell;

FIG. 3 is a cross sectional view taken along line III-III of FIG. 2;

FIG. 4 is a graph showing emission spectra of a discharge gas containing Xe; and

FIG. 5 is a graph showing the VUV transmittances of materials of a protective film.

### DESCRIPTION OF THE PREFERRED EMBODIMENTS

According to the present invention, the pair of substrates may be any if they are disposed in an opposite relation with the discharge space formed therebetween. Examples of substrates include a glass substrate, a quartz substrate, a ceramic substrate and a substrate having thereon desired construction(s) such as an electrode, an insulating film, a dielectric layer and/or a protective film.

The plurality of electrodes are formed on one of the pair of substrates. Various materials known in the art are usable to form the electrode. Materials of the electrode include transparent conductive materials such as ITO and SnO₂ and conductive metal materials such as Ag, Au, Al, Cu and Cr. Various methods known in the art are usable to form the electrode. For example, a thick film formation technique such as printing or a thin film formation technique such as a physical deposition method or a chemical deposition method may be used to form the electrode. Examples of the thick film formation techniques include screen printing. Examples of the physical deposition methods among the thin film formation techniques include vapor deposition and sputtering. Examples of the chemical deposition methods include heat CVD, photo CVD and plasma-enhanced Chemical Vapor Deposition.

The dielectric layer is formed to cover the plurality of electrodes provided on the substrate. The dielectric layer is formed of a material containing silicon oxide such as SiO₂. When SiO₂ is used as the dielectric layer, vapor deposition or CVD for example, which is a technique known in the art, is used to form the dielectric layer.

The discharge gas may be any if it contains xenon (Xe) and is filled in the discharge space. Examples of the discharge gases include a mixture gas of Xe and Ne in which the concentration of Xe is 4 to 100%. As the concentration of Xe in the discharge gas is increased, the emission efficiency of the PDP increases. As the concentration of Xe is increased, however, the ultraviolet light generated by the electric discharge has an increasing average wavelength, so that an increasing amount of ultraviolet light passes through the protective film to reach the dielectric layer. Even when the concentration of Xe is as low as 4%, the electric discharge generates a trace amount of VUV of long wavelengths, so that the PDP cannot acquire long-term reliability.

The protective film is formed to cover the dielectric layer provided on the substrate. The protective film is formed of a material that has little aptitude to pass the ultraviolet light generated by the electric discharge between the electrodes.

The protective film may be formed of a metal oxide composition comprising, as a main component, one selected from the group consisting of CaO, SrO and BaO and a mixture of two or more of these, or a mixture of said metal oxide composition with MgO.

Or, the protective film may be formed of a metal oxide composition comprising, as a main component, one selected from the group consisting of a (Ca, Sr)O compound, wherein the expression “(Ca, Sr)O” means a mixture of CaO and SrO; ditto for the following, a (Ca, Ba)O compound, a (Sr, Ba)O compound and a (Ca, Sr, Ba)O compound and a mixture of two or more of these, or a mixture of said metal oxide composition with MgO.

With the above constitutions, a wavelength to be cut off in the ultraviolet light generated by the electric discharge between the electrodes may be selected by changing a component ratio of the metal oxide composition.

The protective film may be formed by a thin film formation technique known in the art such as vapor deposition or sputtering.

The present invention will be described in detail based on an embodiment shown in the drawings. It should be understood that the present invention is not limited to the embodiment and that various variations and modifications are possible.

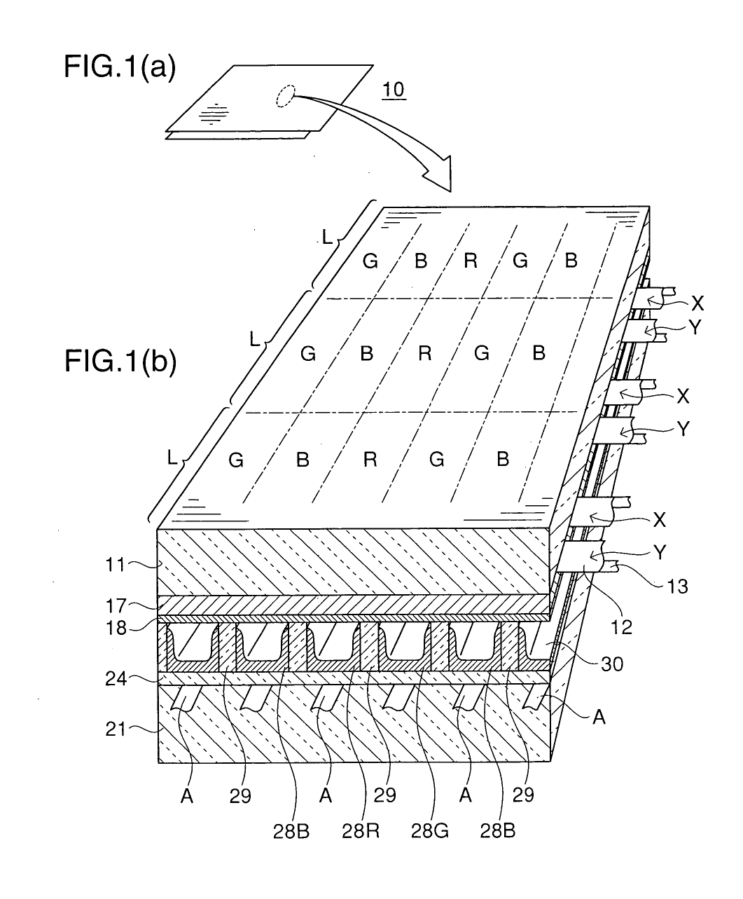

FIGS. 1(a) and 1(b) are explanatory views showing the construction of the PDP according to the present invention. FIG. 1(a) is a view showing the whole PDP and FIG. 1(b) is a partially exploded perspective view. The PDP is an AC-driven three-electrode surface-discharge PDP for display in color.

A PDP 10 according to the present embodiment comprises a front substrate 11 and a rear substrate 21. The front substrate 11 and the rear substrate 21 may be a glass substrate, a quartz substrate, a ceramic substrate or the like.

The front substrate 11 has on an inner surface thereof a plurality pairs of display electrodes X and Y arranged horizontally, with non-discharge gaps, where no electric discharge occurs, provided between the pairs of display electrodes X and Y. The gaps between the display electrodes X and Y serve as display lines L. Each of the display electrodes X and Y comprises a wide transparent electrode 12 formed of ITO, SnO₂ or the like and a narrow bus electrode 13 formed of a metal such as Ag, Au, Al, Cu or Cr or of a laminate of these metals (for example, a laminate of Cr/Cu/Cr). A thick film formation technique such as screen printing may be used if the bus electrode is formed of Ag or Au and a thin film formation technique such as vapor deposition or sputtering and an etching technique may be used if the bus electrode is formed of another metal, so that a desired number of display electrodes X and Y having a desired thickness and a desired width can be formed at desired intervals.

In the present embodiment, the PDP has a structure in which the pairs of display electrodes X and Y are arranged with the non-discharge gaps provided between the pairs, as mentioned above. Instead, the PDP may have the so-called ALIS structure in which the display electrodes X and Y are equidistantly arranged, with all the gaps between the adjacent display electrodes X and Y serving as the display lines L.

A dielectric layer 17 for alternate current (AC) driving is formed to cover the display electrodes X and Y. The dielectric layer 17 is formed by depositing SiO₂ by CVD.

A protective film 18 is formed on the dielectric layer 17 so that the dielectric layer 17 can be protected from damage caused by ion bombardment made due to an electric discharge for display. Of alkaline earth metal oxides, the protective film is formed of an oxide such as CaO, SrO or BaO that has little aptitude to pass VUV or of a composite oxide of these. This will be described in detail later.

The rear substrate 21 has on an inner surface thereof a plurality of address electrodes A in a direction crossing the display electrodes X and Y when viewed from the top and a dielectric layer 24 that covers the address electrodes A. The address electrodes A is for generating an address discharge to select a cell to be lit at its intersection with the Y electrode and is formed of a three-layer structure of Cr/Cu/Cr. The address electrode A may be formed of, for example, Ag, Au, Al, Cu or Cr instead. As is the case with the display electrodes X and Y, a thick film formation technique such as screen printing may be used if the address electrode A is formed of Ag or Au and a thin film formation technique such as vapor deposition or sputtering and an etching technique may be used if the address electrode is formed of another material, so that a desired number of address electrodes A having a desired thickness and a desired width can be formed at desired intervals. The same material and the same method as used to form the dielectric layer 17 may be applied to form the dielectric layer 24.

A plurality of barrier ribs 29 in stripes are formed between the adjacent address electrodes A on the dielectric layer 24. The barrier ribs 29 may be formed by sandblasting, printing, photoetching or the like. The sandblasting, for example, is performed as follows. A glass paste comprising a low-melting glass frit, a binder resin, a solvent and the like is applied onto the dielectric layer 24, followed by drying. Then, cutting particles are blasted against the glass paste layer via a cutting mask having openings formed in a barrier-ribs pattern to remove portions of the glass-paste layer exposed to the outside through the openings of the mask, and then the resulting glass-paste layer is fired. When the photoetching is employed, the blasting of the cutting particles is replaced with an exposure and a development via a mask with use of a photosensitive resin as the binder resin, and the resulting paste layer is fired.

Phosphor layers 28R, 28G and 28B of red (R), green (G) and blue (B) colors are formed on side surfaces of the barrier ribs 29 and on areas of the dielectric layer 24 between the barrier ribs. To form the phosphor layers 28R, 28G and 28B, a phosphor paste comprising a phosphor powder, a binder resin and a solvent is applied onto the surfaces of the grooves or recesses, which define the discharge spaces between the barrier ribs 29, by screen printing or by a method using a dispenser. The application of the phosphor paste is repeated for the phosphor layers of each color. Then, the resulting phosphor paste layers are fired. The phosphor layers 28R, 28G and 28B may be formed of a material in sheet (so-called green sheet), comprising a phosphor powder, a photosensitive material and a binder resin, by a photolithographic technique. In such a case, attachment of a sheet of a desired color to the entire display region on the substrate and an exposure and a development are repeated for the phosphor layers of each color so that the phosphor layers of each color can be formed on the surfaces of suitable grooves between the barrier ribs.

The PDP is produced by disposing the front substrate 11 and the rear substrate 21 in an opposite relation so that the display electrodes X and Y cross the address electrodes A, sealing the front substrate 11 and the rear substrate 21 together at the periphery and feeding a discharge gas as a mixture of Xe and Ne into discharge spaces 30 defined between the barrier ribs 29. In the PDP, an intersection of the pair of display electrodes X and Y with the address electrode A in the discharge space 30 serves as one cell (unit luminous area). One pixel is composed of three cells R, G and B.

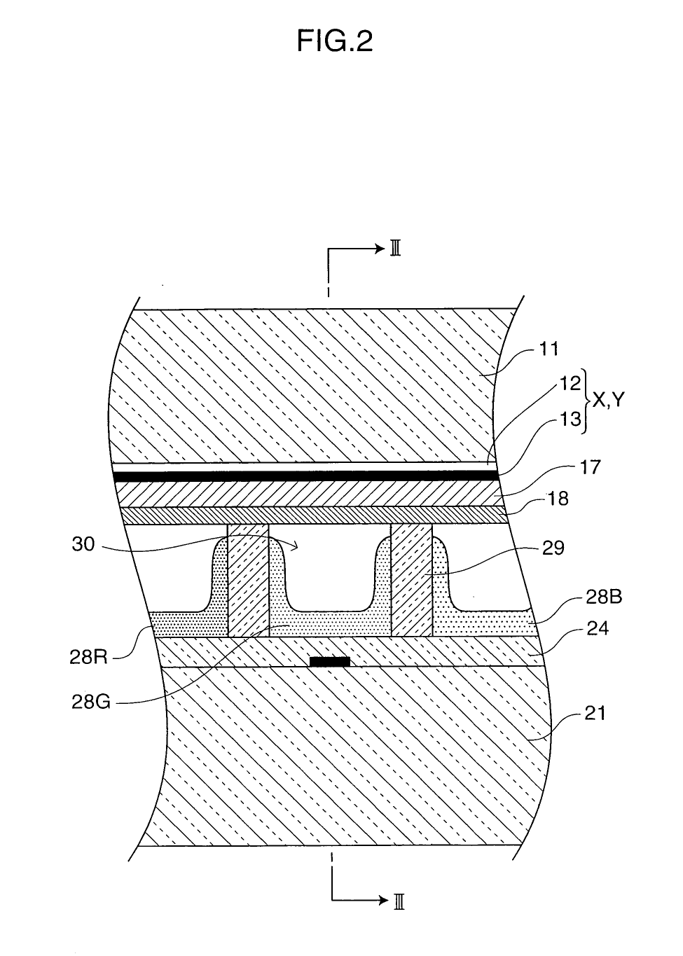

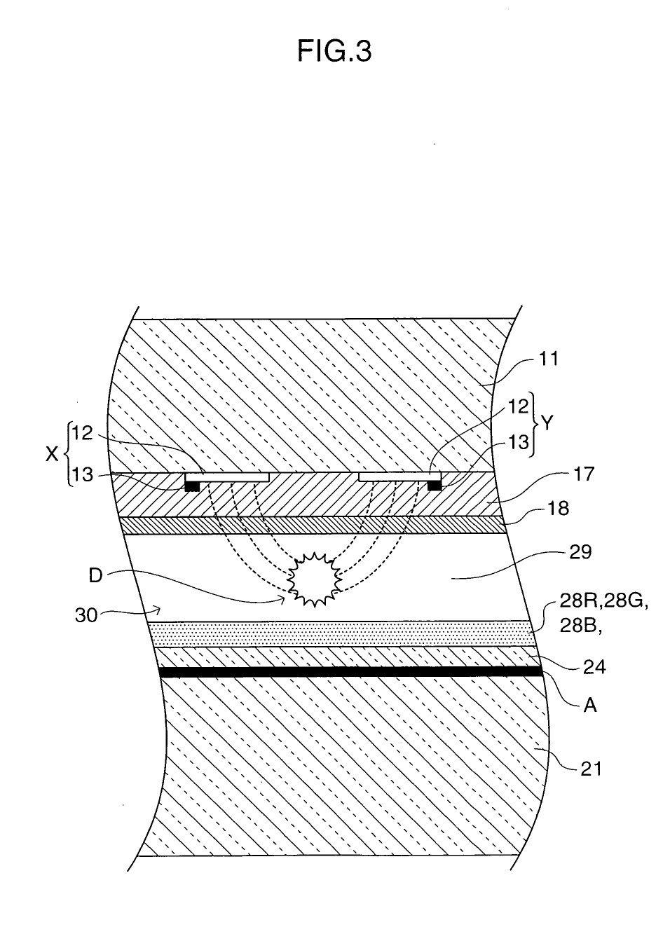

FIG. 2 is an enlarged view of one cell, and FIG. 3 is a cross sectional view taken along line III-III of FIG. 2.

For performing display, a surface discharge D is generated in the discharge space 30 between the transparent electrode 12 of the display electrode X and the transparent electrode 12 of the display electrode Y in the PDP of the present embodiment, as shown in the above figures. The discharge space 30 is filled with the discharge gas as a mixture of Xe and Ne.

During the display discharge, VUV is generated from the discharge gas, and the VUV excites phosphor contained in the phosphor layers 28R, 28G and 28B, so that the phosphor emits visible light in R (red), G (green) and B (blue).

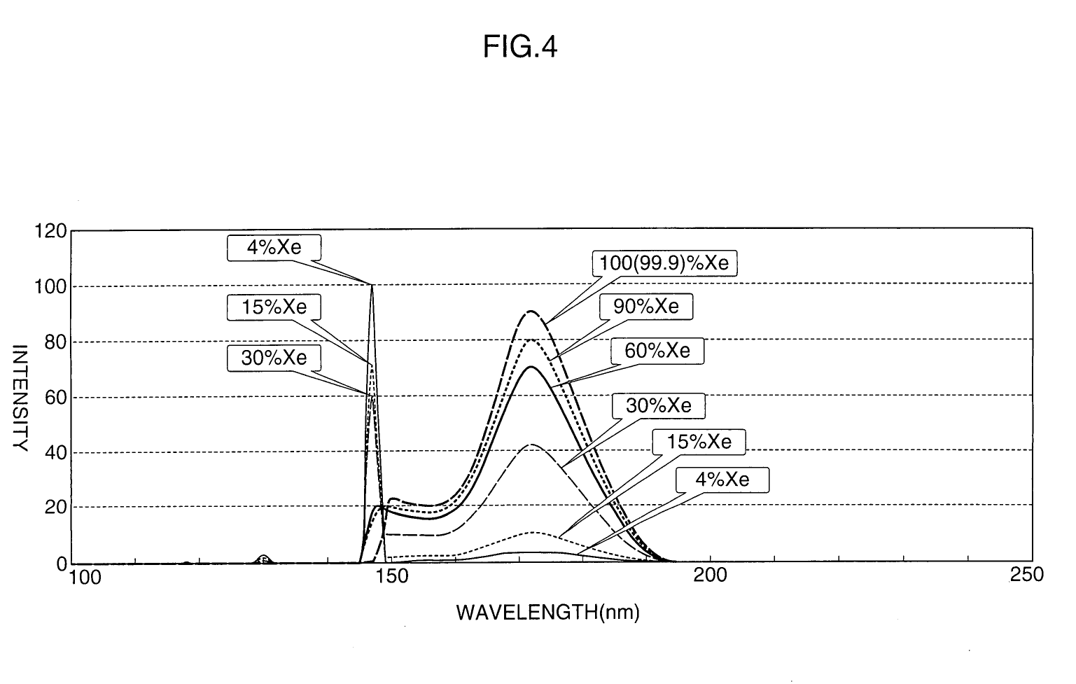

FIG. 4 is a graph showing emission spectra of a discharge gas containing Xe.

The graph is plotted with the wavelengths of VUV generated by an electric discharge as abscissa against the intensities thereof as ordinate.

The graph shows emission spectra obtained at varying concentrations of Xe from 4% to 100(99.9) %. Namely, the graph shows emission spectra obtained when the concentration of Xe is varied in six stages of 4%, 15%, 30%, 60%, 90% and 100(99.9) %. A Ne gas was used to dilute Xe. The expression “100(99.9) %” is given above because a 99.9% cylinder was used.

Even when He, Ar and Kr gases each were used in place of the Ne gas to dilute Xe, the emission spectra were the same in curve slopes as when the Ne gas was used. This indicates that the curve slopes of the emission spectra depended on the concentration of Xe irrespective of the kind of mixture gas.

The graph shows that the emission spectra of the discharge gas containing Xe have two peaks at about 147 nm and at about 172 nm, respectively.

The graph further shows that the emission spectra of the discharge gas containing Xe at concentrations of 30% and less have a high peak at about 147 nm and a low peak at about 172 nm and that the emission spectra of the discharge gas containing Xe at concentrations of 60% and more have a low peak at about 147 nm and a high peak at about 172 nm.

Also, the graph indicates that all the emission spectra of the discharge gas containing Xe are of wavelengths of not greater than about 190 nm.

The concentration of Xe in the discharge gas is set to be within the range of 4 to 100(99.9) %. As the concentration of Xe is increased, the VUV generated by the electric discharge tends to have an increasing average wavelength. If the dielectric layer is formed of a SiO₂ film, on the other hand, the SiO₂ film passes light of wavelengths within the range of about 150 to 4500 nm. The dielectric layer may be formed of a low-melting glass, if the low-melting glass passes light of wavelengths of not greater than 190 nm.

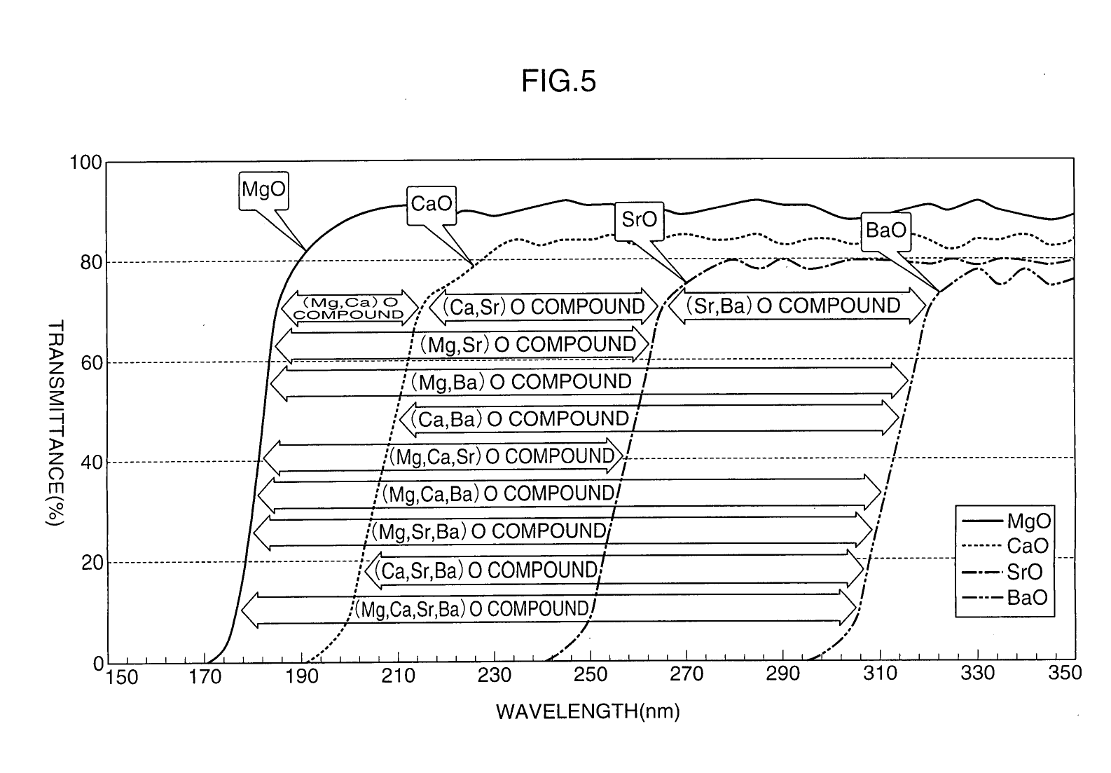

FIG. 5 is a graph showing the VUV transmittances of materials of the protective film.

MgO, CaO, SrO and BaO as materials of the protective film were deposited on respective substrates of magnesium fluoride (MgF₂) each to a thickness of 0.2 μm and the resulting protective films were irradiated with VUV emitted from a deuterium lamp that had been spectrally divided, to measure the VUV transmittances of the materials of the protective film. The results of the measurements are shown in the graph. The protective films were formed by vapor deposition, but various thin film formation techniques known in the art such as vapor deposition and sputtering may be employed.

As shown in the graph, the MgO film passed only light of wavelengths of greater than about 170 nm. In other words, the transmittance of the MgO film was 0% at a wavelength of 170 nm and 90% at wavelengths of 210 nm and greater. The CaO film passed only light of wavelengths of greater than about 190 nm. In other words, the CaO film had a transmittance of 0% at a wavelength of about 190 nm and a transmittance of about 85% at wavelengths of 230 nm and greater. The SrO film passed only light of wavelengths of greater than about 240 nm. In other words, the SrO film had a transmittance of 0% at a wavelength of about 240 nm and it had a transmittance of 80% at wavelengths of about 270 nm and greater. The BaO film passed only light of wavelengths of greater than about 290 nm. In other words, the BaO film had a transmittance of 0% at a wavelength of about 290 nm and a transmittance of about 75% at wavelengths of about 330 nm and greater.

The MgO film passed light of wavelengths of greater than about 170 nm as indicated above, while the VUV generated during the electric discharge, on the other hand, is light of wavelengths within the range of 145 to 190 nm, as shown in FIG. 4. This means that the MgO film passes part of the VUV generated during the electric discharge.

On the other hand, the CaO film, SrO film and BaO film do not pass light of wavelengths of 190 nm and smaller. This means that the CaO film, SrO film and BaO film do not pass the VUV, of wavelengths within the range of 145 to 190 nm, generated during the electric discharge.

Also, protective films formed of composite oxides as any combination of CaO, SrO and BaO do not pass the VUV, of wavelengths within the range of 145 to 190 nm, generated during the electric discharge. In other words, protective films formed of composite oxides respectively containing a (Ca, Sr)O compound, a (Sr, Ba)O compound, a (Ca, Ba)O compound and a (Ca, Sr, Ba)O compound do not pass light of wavelengths of 190 nm and smaller. Wavelengths to be cut off by (not to pass through) the composite oxides vary within the ranges indicated by respective arrows in the graph according to approximately component ratios of the composite oxides.

MgO may be incorporated into the composite oxides which are any combination of CaO, SrO and BaO. This is because while a protective film formed of MgO serving as a single oxide passes light of wavelengths of greater than about 170 nm as mentioned above, wavelengths to be cut off by (not to pass through) the composite oxides vary according to component ratios of the composite oxides as described above. If MgO is incorporated into the composite oxides which are any combination of CaO, SrO and BaO, a wavelength to be cut off can be selected within a proper range.

Namely, the amount of light of wavelengths of 190 nm and smaller which passes through composite oxides respectively containing a (Mg, Ca)O compound, a (Mg, Sr)O compound, a (Mg, Ba)O compound, a (Mg, Ca, Sr)O compound, a (Mg, Ca, Ba)O compound, a (Mg, Sr, Ba)O compound and a (Mg, Ca, Sr, Ba)O compound, as well as MgO, can be varied according to the contents of the MgO. No light of wavelengths of 190 nm and smaller passes through the composite oxides depending on the contents of the MgO.

More specifically, if the protective film is formed of a composite oxide containing a (Mg, Ca)O compound, a wavelength to be cut off within the range of about 170 to 190 nm can be selected by changing a component ratio of the composite oxide.

If the protective film is formed of a composite oxide containing a (Ca, Sr)O compound, a wavelength to be cut off within the range of about 190 to 240 nm can be selected by changing a component ratio of the composite oxide.

If the protective film is formed of a composite oxide containing a (Sr, Ba)O compound, a wavelength to be cut off within the range of about 240 to 290 nm can be selected by changing a component ratio of the composite oxide.

If the protective film is formed of a composite oxide containing a (Mg, Sr)O compound or a (Mg, Ca, Sr)O compound, a wavelength to be cut off within the range of about 170 to 240 nm can be selected by changing a component ratio of the composite oxide.

If the protective film is formed of a composite oxide containing a (Ca, Ba)O compound or a (Ca, Sr, Ba)O compound, a wavelength to be cut off within the range of about 190 to 290 nm can be selected by changing a component ratio of the composite oxide.

If the protective film is formed of a composite oxide containing a (Mg, Ba)O compound, a (Mg, Ca, Ba)O compound, a (Mg, Sr, Ba)O compound or a (Mg, Ca, Sr, Ba)O compound, a wavelength to be cut off within the range of about 170 to 290 nm can be selected by changing a component ratio of the composite oxide.

As mentioned above, by using, as a material of the protective film of the PDP, alkaline earth metal oxides respectively containing CaO, SrO and BaO which have little aptitude to pass VUV; composite oxides of these (for example, a mixture of CaO and SrO or a mixture of SrO and BaO); and composite oxides thereof with MgO (for example, a mixture of MgO and SrO or a mixture of MgO and BaO), the VUV generated during the electric discharge can be blocked by the protective film from entering the dielectric layer. Since the VUV does not reach the dielectric layer, the amount of the impurity gas generated from the dielectric layer can be reduced even if the dielectric layer is formed of a SiO₂ film that has an aptitude to pass the VUV. This prevents contamination of the discharge gas filled in the PDP to ensure stabilized discharge characteristics and a long life of the PDP.

The PDP may have an ultraviolet-light shielding film on the front-substrate side thereof in terms of blockage of the VUV generated during the electric discharge from entering the dielectric layer. If the protective film is formed of an alkaline earth metal composite oxide in the present invention, the alkaline earth metal composite oxide has two functions one as the protective film and the other as the ultraviolet-light shielding film so that the PDP has a simple structure.

The alkaline earth metal composite oxide has an effect of lowering a driving voltage. If the protective film is formed of a mixture of CaO and SrO, the driving voltage can be about 20 to 30% lower than if it is formed of MgO.

Further, since the dielectric layer can be formed of a SiO₂ film that has an aptitude to pass the VUV, the dielectric layer can have a lower permittivity than when it is formed of a low-melting glass. Accordingly, if the dielectric layer is reduced in thickness while the capacitance thereof is set at the same value as that obtained when the dielectric layer is formed of the low-melting glass, the driving voltage can be reduced while keeping the same discharge current.

In general, an increase in the concentration of Xe in the discharge gas causes a rise in discharge voltage. If the protective film is formed of an alkaline earth metal composite oxide and the dielectric layer is formed of a SiO₂ film, however, the discharge voltage can be significantly decreased so that the concentration of Xe can be increased to raise the emission efficiency of the PDP for the decrease in discharge voltage.

As mentioned above, if the protective film is formed of an alkaline earth metal composite oxide that has little aptitude to pass the VUV, generation of the impurity gas from the dielectric layer can be prevented irrespective of whether the dielectric layer is formed of a film containing SiO₂ to reduce the permittivity thereof. Thus, the present invention can make it possible to produce a highly reliable and highly efficient PDP.

According to the present invention, ultraviolet light that is generated by the electric discharge between the electrodes is blocked by the protective film from entering the dielectric layer. As a result, generation of the impurity gas from the dielectric layer that is formed of a material containing silicon oxide is prevented. Consequently, contamination of the discharge gas filled in the PDP is prevented.

1. A plasma display panel comprising:
a pair of substrates disposed in an opposite relation with a discharge spaced defined therebetween;
a dielectric layer formed on at least one of the substrates so that the dielectric layer covers a plurality of electrodes formed on said at least one of the substrates;
a protective film formed on the dielectric layer so that the protective film covers the dielectric layer; and
a discharge gas filled in the discharge space, the discharge gas containing xenon,
wherein the dielectric layer is formed of a material containing silicon oxide, and
the protective film is formed of a material that has little aptitude to pass ultraviolet light generated by an electric discharge between the electrodes.

2. The plasma display panel of claim 1, wherein the protective film is formed of a metal oxide composition comprising, as a main component, one selected from the group consisting of CaO, SrO and BaO and a mixture of two or more of these, or a mixture of said metal oxide composition with MgO.

3. The plasma display panel of claim 1, wherein the protective film is formed of a metal oxide composition comprising, as a main component, one selected from the group consisting of a (Ca, Sr)O compound, a (Ca, Ba)O compound, a (Sr, Ba)O compound and a (Ca, Sr, Ba)O compound and a mixture of two or more of these, or a mixture of said metal oxide composition with MgO.

4. The plasma display panel of claim 2, wherein a wavelength to be cut off in the ultraviolet light generated by the electric discharge between the electrodes is selected by changing a component ratio of the metal oxide composition.

5. The plasma display panel of claim 1, wherein the concentration of the xenon in the discharge gas is 4% or more.

6. The plasma display panel of claim 1, wherein the dielectric layer is formed by CVD.

7. The plasma display panel of claim 2, wherein the dielectric layer is formed by CVD.

8. The plasma display panel of claim 5, wherein the dielectric layer is formed by CVD.

9. The plasma display panel of claim 3, wherein a wavelength to be cut off in the ultraviolet light generated by the electric discharge between the electrodes is selected by changing a component ratio of the metal oxide composition.
